(19) United States
(12) Patent Application Publication
(10) Pub. No.: US 2002/0007471 A1
(43) Pub. Date: Jan. 17, 2002

(54) Current-supply buffer device for computer peripherals

(76) Inventor: Yu Chang, Kaohsiung (TW)

Correspondence Address: RABIN & CHAMPAGNE, P.C., 1725 K Street, N.W., Suite 1111, Washington, DC, 20006, US

(21) Appl. No.: 09/863,410

(22) Filed: May 24, 2001

(30) Foreign Application Priority Data
Jul. 11, 2000 (TW) 089211906

(51) Int. Cl. G06F 11/00

(52) U.S. Cl. 714/25

(57) ABSTRACT

A current-supply buffer device for peripherals of a computer having a power supply providing more than two sets of output voltage sources, includes an internal circuit board; two power connectors separately connected to input and output end of the circuit board for electrically connecting to an output at a rear part of the computer power supply and an input of a built-in unit of the computer, respectively; and a capacitance provided on the circuit board to parallelly connect to each voltage source between an input and an output thereof. Due to a charging and discharging ability of the capacitances, the device functions as a voltage and current buffer to protect built-in units against unstable operation and serious damages caused by instantaneous start-on of too many built-in units at the same time or overly high instantaneous power of the built-in units in use.

### BACKGROUND OF THE INVENTION

The present invention relates to a current-supply buffer device, and more particularly to a current-supply buffer device for mounting in a computer between a current-supply device and a built-in unit to avoid instantaneously insufficient supply of current and unstable computer operation caused by instantaneous start-on of too many built-in units at the same time, and to avoid unstable operation of and even serious damages to built-in units caused by an overly high instantaneous power of the built-in units in use.

A computer plays an important role in many occasions in nowaday high-tech environment and there are more and more built-in units provided for the computer. Such built-in units must work under very strict current-supply requirements. For instance, unstable power supply would often cause failure in recording a compact disc using a CD-ReWritable (CD-RW). FIG. 1 shows the connection of a conventional computer current-supply device to multiple built-in units. As shown, there is only one current-supply device 1 provided in the computer while there are a number of built-in units 11, such as a CD-RW, a Hard Disk (HD), a Mini Disk (MD), a Digital Versatile Disk (DVD), etc. In this case, it is very possible an instantaneously insufficient supply of current would occur. If a built-in unit 11 were booted when an instantaneous current-supply insufficiency occurs, it would result in unstable operation of the computer current-supply device 1 and accordingly, loss of computer data or unwanted downtime of computer. Or, when there are a number of high-power built-in units 11 for use, the starting up of all these high-power built-in units 11 simultaneously would very possibly produce an instantaneous high power to result in unstable operation of or even serious damages to these built-in units.

The following summarizes disadvantages of the connection of only one conventional computer current-supply device to multiple built-in units:

1. It is very possible an instantaneously insufficient supply of current would occur. If an additional built-in unit were booted when an instantaneous current-supply insufficiency occurs, it would result in unstable operation of the computer current-supply device and accordingly, loss of computer data or unwanted downtime of computer.

2. When there are a number of high-power built-in units for use, the starting up of all these high-power built-in units simultaneously would very possibly produce an instantaneous high power to result in unstable operation of or even serious damages to these built-in units.

In view of the above-mentioned drawbacks existing in the conventional computer current-supply device, it is tried by the inventor to develop a current-supply buffer device for computer peripherals for mounting in a computer between the conventional current-supply device and multiple built-in units to avoid instantaneously insufficient supply of current and unstable computer operation caused by instantaneous booting of too many built-in units at the same time, and to avoid unstable operation of and even serious damages to built-in units caused by an overly high instantaneous power of the built-in units in use.

### SUMMARY OF THE INVENTION

A primary object of the present invention is to provide a current-supply buffer device for a current-supply device in a computer, in order to avoid instantaneously insufficient supply of current and unstable computer operation caused by instantaneous booting of too many built-in units at the same time, and to avoid serious damages to built-in units caused by an overly high instantaneous power of the built-in units in use.

To achieve the above and other objects, the present invention provides a current-supply buffer device suitable for use with a computer that has a power supply having a rear part providing more than two sets of output voltage sources. The device mainly includes an internal circuit board; two power connectors separately connected to an input end and an output end of the circuit board for electrically connecting to an output at the rear part of the computer power supply and an input of a built-in unit of the computer, respectively; and a capacitance provided on the circuit board to parallelly connect to each voltage source between an input and an output thereof. Due to a charging and discharging ability of the capacitances, the device functions as a voltage and current buffer for the built-in unit to avoid instantaneously insufficient supply of current and unstable computer operation caused by instantaneous start-on of too many built-in units at the same time and to avoid unstable operation of and even serious damages to the built-in units caused by an overly high instantaneous power of the built-in units in use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the connection of a conventional computer current-supply device to multiple built-in units;

FIG. 2 is a circuit diagram of a current-supply buffer device for computer peripherals according to the present invention;

FIG. 3 is a perspective view of the current-supply buffer device for computer peripherals according to the present invention; and

FIG. 4 shows the connection of the current-supply buffer device of the present invention at two ends to the conventional computer current-supply device and multiple built-in units.

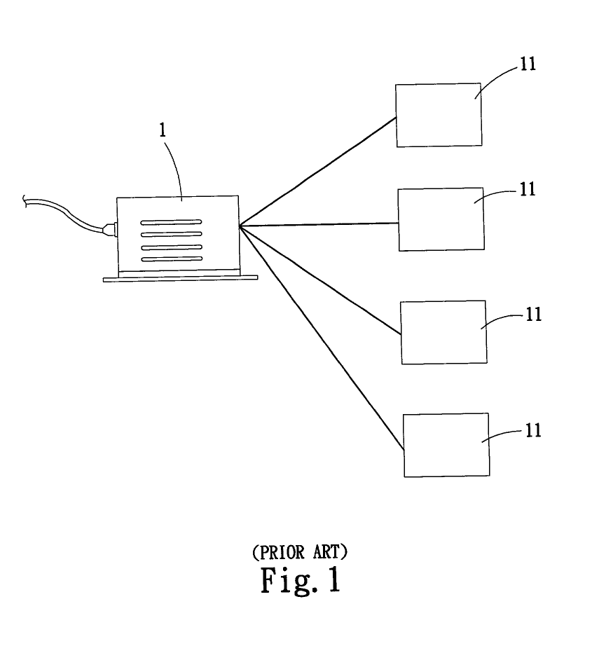

### DETAILED DESCRIPTION OF THE PREFERRED EMBODIMENTS

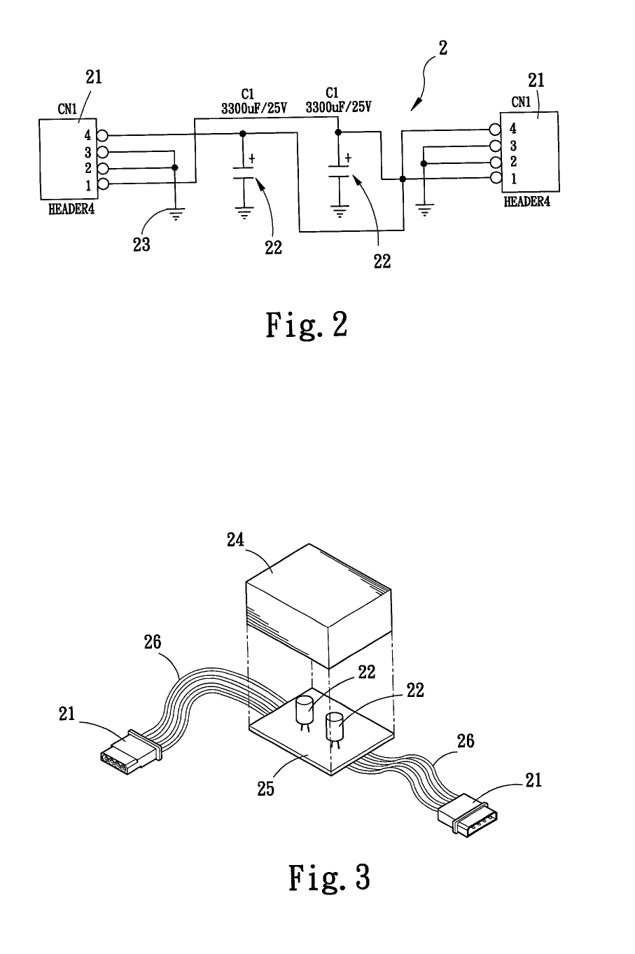

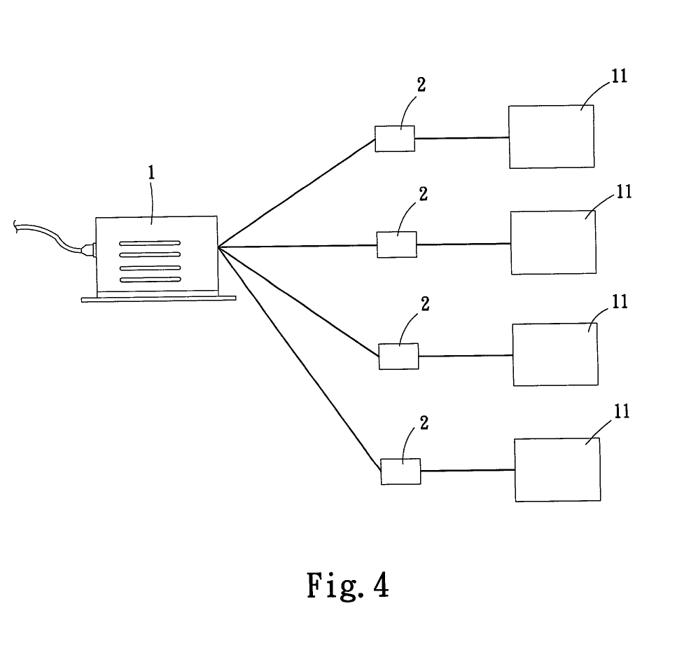

Please refer to FIG. 2 that is a circuit diagram of a current-supply buffer device 2 according to the present invention for computer peripherals 11. As shown, the current-supply buffer device 2 includes at least two power connectors 21 and two capacitances 22. Each power connector 21 has four pins, and the four pins on one power connector 21 respectively correspond to the four pins on the other connector 21 when they are electrically connected to one another, so that the two power connectors 21 separately form an input end and an output end of the device 2. Typically, the current-supply device 1 provides two types of output voltage, that is, 5V and 12V. In the present invention, the first and the fourth pins of the power connectors 21 are designed for electrically connecting to the 5V and the 12V outputs, respectively, and the second and the third pins of the power connectors 21 are connected to a common ground 23. To stabilize voltage and current, the first pins of the two power connectors 21 and one of the two capacitances 22, that are 3300UF/25V, are connected in parallel, and the fourth pins of the two power connectors 21 and the other capacitance 22 are connected in parallel. Whereby, when the current-supply device 1 of the computer has an instantaneously dropped output voltage, the capacitances 22 discharge instantaneously to stabilize the voltage. And, when the current-supply device 1 of the computer restores to a stable output voltage, the capacitances 22 automatically recharge. By this way, it is possible to effectively avoid instantaneously insufficient supply of current and unstable computer operation caused by instantaneous booting of too many built-in units at the same time, as well as serious damages to built-in units caused by an overly high instantaneous power of the built-in units in use.

Alternatively, each capacitance 22 of 3300UF/25V may be replaced with a capacitance of 2200UF/25V parallelly connected to a capacitance of 1100UF/25V to obtain the same capacitivity and to provide an even better protective effect.

Please refer to FIG. 3 that is a perspective view of the current-supply buffer device 2 of the present invention. As shown, the current-supply buffer device 2 utilizes two capacitances 22 that are mounted on a circuit board 25. Two power connectors 21 are separately connected two sides of the circuit board 25 via two flat cables 26. The capacitances 22, the power connectors 21, and the flat cables 26 are connected in the manner shown in the circuit diagram of FIG. 2. A case 24 houses the circuit board 25. The flat cables 26 at two sides of the circuit board 25 have different lengths. The power connector 21 connected to the longer flat cable 26 is used to connect to a built-in unit 11, and the other power connector 21 connected to the shorter flat cable 26 is used to connect to a rear end of the current-supply device 1 for the computer.

With the above specific arrangements, the current-supply buffer device of the present invention has the following features:

1. The current-supply buffer device for computer peripherals has small volume and is adapted to hang in the computer without occupying too much room or changing an appearance of the computer.

2. When the current-supply device of the computer has an instantaneously dropped output voltage, the capacitances discharge instantaneously to stabilize the voltage. And, when the current-supply device of the computer restores to a stable output voltage, the capacitances 22 automatically recharge. Whereby, it is possible to effectively avoid instantaneously insufficient supply of current and unstable computer operation caused by instantaneous booting of too many built-in units at the same time, as well as serious damages to built-in units caused by an overly high instantaneous power of the built-in units in use.

3. The current-supply buffer device of the present invention may be easily produced at low manufacturing cost and is suitable for mass production.

4. Each capacitance of 3300UF/25V maybe replaced with a capacitance of 2200UF/25V parallelly connected to a capacitance of 1100UF/25V to obtain the same capacitivity and to provide an even better protective effect.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A current-supply buffer device for peripherals of a computer that has a power supply, a rear part of which having more than two sets of output voltage sources, said device comprising an internal circuit board; two power connectors separately connected to an input end and an output end of said circuit board for electrically connecting to an output at the rear part of the computer power supply and an input of a built-in unit of the computer, respectively; and a predetermined number of capacitance provided on said circuit board to parallelly connect to each voltage source between an input and an output thereof; whereby, due to a charging and discharging ability of said capacitances, said device functions as a voltage and current buffer for said built-in unit to avoid instantaneously insufficient supply of current and unstable computer operation caused by instantaneous start-on of too many said built-in units at the same time and to avoid unstable operation of and even serious damages to said built-in units caused by an overly high instantaneous power of said built-in units in use.

2. The current-supply buffer device for peripherals of a computer as claimed in claim 1, wherein said power connector connected to the input of said circuit board is connected via a shorter flat cable while said power connector connected to the output of said circuit board is connected via a longer flat cable.

3. The current-supply buffer device for peripherals of a computer as claimed in claim 1, wherein each said voltage source is parallelly connected to one capacitance to obtain a required capacitivity.

4. The current-supply buffer device for peripherals of a computer as claimed in claim 1, wherein each said voltage source is parallelly connected to two capacitances that are parallelly connected to obtain a required capacitivity.
